(19) United States
(12) Patent Application Publication
(10) Pub. No.: US 2023/0368002 A1
(43) Pub. Date: Nov. 16, 2023

(54) MULTI-SCALE ARTIFICAL NEURAL NETWORK AND A METHOD FOR OPERATING SAME FOR TIME SERIES FORECASTING

(71) Applicant: Royal Bank of Canada, Toronto (CA)

(72) Inventors: Amin SHABANI, Coquitlam (CA); Tristan SYLVAIN, Montreal (CA); Lili MENG, Vancouver (CA); Amir ABDI, Vancouver (CA)

(21) Appl. No.: 18/197,197

(22) Filed: May 15, 2023

Related U.S. Application Data
(60) Provisional application No. 63/342,399, filed on May 16, 2022.

(51) Int. Cl. G06N 3/047; G06N 3/096

(52) U.S. Cl. CPC G06N 3/047; G06N 3/096

(57) ABSTRACT

A method for operating a neural network using an encoder-based model to provide a time series forecast, the method comprising: down sampling a time series dataset to generate an initial input having a first scale resolution, such that the first scale resolution is less than a scale resolution of the time series dataset; processing as a first iteration, using the model, the initial input to generate a first output; upsampling by an upsampling function the first output to generate a second input having a second scale resolution, the second scale resolution being higher than the first scale resolution, such that the second input is based on the first output; and processing as a second iteration, using the model, the second input to generate a second output; wherein the second output represents a time series forecast of the time series dataset.

### TECHNICAL FIELD

The present disclosure is directed at artificial neural networks applied to time series forecasting.

### BACKGROUND

Time Series Forecasting is among the most well-known problems in many domains such as sensor network monitoring, traffic and economics planning, astronomy, economic and financial forecasting, inventory planning, and weather and disease propagation forecasting. While many attempts have been made for using Neural Networks in Time Series Forecasting several years ago, with the recent advances in Deep Neural Networks, there also has been a rapid rise in the use of DNNs for Time Series Forecasting along with many other machine learning tasks. Considering the approaches which have been proposed to process sequential inputs, initial works in this field focused primarily on Recurrent Neural Networks such as LSTMs and GRUs.

Salinas et al., Probabilistic forecasting with autoregressive recurrent networks International Journal of Forecasting, 36(3): 1181-1191, 2020, proposed DeepAR as an auto-regressive model based on RNNs to model the probabilistic distribution of future series. Although the RNN-based models can achieve reasonable results, one of the major drawbacks to adopting these models is the vanishing/exploding gradient problem which makes them a less suitable choice for predicting long sequence time series. Advances in the state of the art overcame the vanishing gradient problem of RNNs by proposing Transformers, a deep neural network based on self-attention modules. In contrast with the RNN-based models in which the input sequence will be processed sequentially, Transformers can process all of the input sequence together using the attention mechanism which makes the model able to process longer sequences. However, none of these improvements address the need for predictions in long sequence time series, which improve the ability of the computations to provide model flexibility while at the same time inhibiting computational drift away from the desired solution of the output series.

There are several existing methods targeting the memory and time efficiency of Transformers. However, the focus of these methods is mainly on improving the attention mechanism or adding time-series-based modules such as Series-Decomposition.

Since time-series forecasting plays an important roles in many domains, there exits a vast variety of time-series forecasting known in the art. Traditional methods such as ARIMA models and deep exponential models have existed for a long time. Recurrent Neural Networks (RNNs) dominated the time series forecasting in the early machine learning based methods. DeepAR is based on training an auto-regressive RNN model on a large number of related time series. DeepState combines traditional state-space model with RNNs. Convolutional Networks (TCN) later shows a comparable or even better results across a diverse range of tasks and datasets compared with RNNs based model. Recent work in the state of the art applied transformers to time-series forecasting by leveraging self-attention mechanisms to learn complex patterns and dynamics from time series data. Examples of transformer application in the art includes: applying transformer-based model to multivariate time series forecasting; a probabilistic, non-auto-regressive transformer-based model with the integration of state space models with state-of-the-art accuracy for univariate and multivariate time-series forecasting tasks; Informer architecture by using Prob Sparse Attention instead of the Full Attention in the original transformers to improve the time complexity from O(L\hat{ }2) to O(L log L); and Autoformer using a cross-correlation-based attention (AutoCorrelation) to not only obtain the scores but also compare the local information as well as the points-wise information. However, none of these state of the art improvements address the need for predictions in long sequence time series, which improve the ability of the computations to provide model flexibility while at the same time inhibiting computational drift away from the desired solution of the output series.

Multiscale Vision Transformers have been used for video and image recognition, by connecting the seminal idea of multiscale feature hierarchies with transformer models, however, these methods focus on the spatial domain, specially designed for computer vision tasks.

### SUMMARY

It is an object of the present invention to provide a system and method for time series forecasting that obviates or mitigates at least one of the above presented disadvantages.

One object of the present invention is to provide passing an input series in multiple different resolutions in order to facilitate a network network to compute and forecast different components in Time Series Forecasting.

According to a first aspect, there is provided a method for operating a neural network using an encoder-based model to provide a time series forecast, the method comprising: down sampling a time series dataset to generate an initial input having a first scale resolution, such that the first scale resolution is less than a scale resolution of the time series dataset; processing as a first iteration, using the model, the initial input to generate a first output; upsampling by an upsampling function the first output to generate a second input having a second scale resolution, the second scale resolution being higher than the first scale resolution, such that the second input is based on the first output; and processing as a second iteration, using the model, the second input to generate a second output; wherein the second output represents a time series forecast of the time series dataset.

According to another aspect, there is provided a system comprising: a processor; a database storing a time series dataset that is communicatively coupled to the processor; and a memory that is communicatively coupled to the processor and that has stored thereon computer program code that is executable by the processor and that, when executed by the processor, causes the processor to retrieve the time series dataset from the database and to use the time series dataset using an encoder-based model to provide a time series forecast by: down sampling a time series dataset to generate an initial input having a first scale resolution, such that the first scale resolution is less than a scale resolution of the time series dataset; processing as a first iteration, using the model, the initial input to generate a first output; upsampling by an upsampling function the first output to generate a second input having a second scale resolution, the second scale resolution being higher than the first scale resolution, such that the second input is based on the first output; and processing as a second iteration, using the model, the second input to generate a second output; wherein the second output represents a time series forecast of the time series dataset.

According to another aspect, there is provided an artificial neural network for operating a neural network using an encoder-based model to provide a time series forecast, by: down sampling a time series dataset to generate an initial input having a first scale resolution, such that the first scale resolution is less than a scale resolution of the time series dataset; processing as a first iteration, using the model, the initial input to generate a first output; upsampling by an upsampling function the first output to generate a second input having a second scale resolution, the second scale resolution being higher than the first scale resolution, such that the second input is based on the first output; and processing as a second iteration, using the model, the second input to generate a second output; wherein the second output represents a time series forecast of the time series dataset.

According to another aspect, there is provided a non-transitory computer readable medium having stored thereon computer program code that is executable by a processor and that, when executed by the processor, causes the processor for operating a neural network using an encoder-based model to provide a time series forecast, the method comprising: down sampling a time series dataset to generate an initial input having a first scale resolution, such that the first scale resolution is less than a scale resolution of the time series dataset; processing as a first iteration, using the model, the initial input to generate a first output; upsampling by an upsampling function the first output to generate a second input having a second scale resolution, the second scale resolution being higher than the first scale resolution, such that the second input is based on the first output; and processing as a second iteration, using the model, the second input to generate a second output; wherein the second output represents a time series forecast of the time series dataset.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts an example neural network using multi resolution iteration;

FIG. 2 depicts an example operation of the network of FIG. 1;

FIG. 3 depicts an example computer system that may be used to implement the neural network of FIG. 1; and

FIG. 4 shows an example result of iterative operation of the network of FIG. 1;

FIGS. 5A, 5B show further example results of the operation of the network of FIG. 1.

### DETAILED DESCRIPTION

Multi-scale neural networks using multi-scale and hierarchical processing is a known technique in deep neural networks DNN literature. Different transformations of a time series have been used such as down-sampling and smoothing along with the original signal in parallel as a part of the network to better capture temporal patterns and reduce the effect of random noise. Many attempts have been made in the state of the art on improving recurrent neural networks RNN in tasks such as language processing, computer vision, time-series analysis, and Speech Recognition. However, these methods are mainly focused on proposing a new RNN-based module, which is unfortunately not applicable to transformers directly. This same direction has been also investigated in Transformers, TCN, and MLP models. In the most recent work, multi-scale segment-wise correlations have been used as a multi-scale version of the self-attention mechanism. However, these known works, including applications to Transformers, do not use a model-agnostic framework to utilize multi-scale time series in encoder-based models (e.g. transformers), while keeping the number of parameters and time complexity roughly the same, as is provided by the below discussed method 200 using the provided framework/network 100. As such, it is understood that state of the art solutions using transformers do not address the need for the method 200 provided predictions in long sequence time series, which improve the ability of the computations to provide model flexibility while at the same time can inhibit computational drift away from the desired solution of the output series.

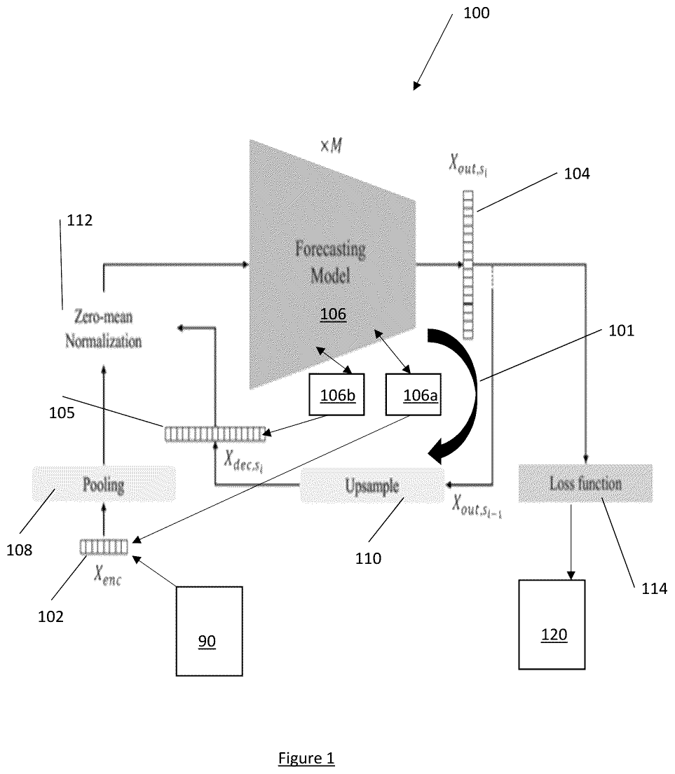

Referring to FIG. 1, the following discusses a new framework/network 100 for time-series forecasting using Transformer models 106, as a demonstrative example of encoder-based models, which is applicable to adapt most of the recent state-of-the-art methods for forecasting. The framework/network 100 benefits from considering the time-series of a dataset 90 in different resolutions (e.g. multiscale) which makes the model 106 able to focus on different components of the time series. Provided are example results/experiments on five public datasets 90 showing the effectiveness of the framework/network 100 by realizing better or comparable results in comparing with the baseline computations (see tables 1, 1A, 2, 2A, 3, 3A, 4, 5). In particular, it is recognized that in each iterative step, we pass the normalized upsampled output from previous step/iteration along with the normalized downsampled encoder as the input. Therefore, the provided network 100 processes the input in a multi-scale manner iteratively from the smallest scale to the original scale, as a model-agnostic framework 100 to utilize multi-scale time-series 90 in (e.g. transformer) models 106 while keeping the number of parameters and time complexity roughly the same.

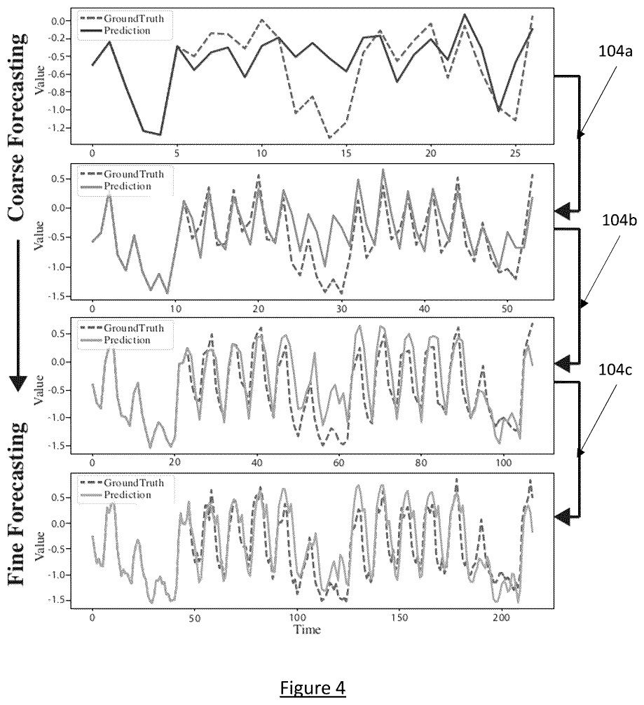

In particular, provided is a general multi-scale framework 100 that can be applied to the state-of-the-art transformer-based time series forecasting models 106 (FEDformer, Autoformer, etc.). By iteratively refining a forecasted time series (e.g. dataset 90) at multiple scales (e.g. see FIG. 4 example results with intermediate forecasts 104a,b,c using the method 200 at different time scales) with shared weights, introducing architecture adaptations, and a specially-designed normalization scheme, we are able to achieve significant performance improvements, from 5:5% to 38:5% across datasets and transformer architectures, with minimal additional computational overhead.

As further described below, we enable scale-awareness (iterative multiscale application of the network 100) showcased by example in FIG. 4, using time series forecasts are iteratively refined at successive time-steps, allowing the model 106 to better capture the inter-dependencies and specificities of each scale—(e.g. each resolution input to the model 106). However, it is recognized that iterative refinement at different scales can cause distribution shifts between intermediate forecasts, which can lead to runaway error propagation. To mitigate this potential issue, optionally we can introduce cross-scale normalization at each iterative step, as further discussed below. Leveraging this, we chose to operate the network 100 with various transformer-based backbones (e.g. Fedformer, Autoformer, Informer, Reformer, Performer) to further probe the effect of the multi-scale method 200 on a variety of experimental setups.

Referring to FIG. 1, shown is the artificial neural network 100 for time series foecasting for datasets 90 (see examples in table 1A, 1B). It is recognised that a time series dataset 90 contains an explicit order dependence (in a time dimension) between each of the discrete observations making up the series. This time dimension can be both a constraint and a structure that provides a source of additional information for the dataset 90, such that a time series dataset 90 can be referred to as a sequence of observations taken sequentially in time. In terms of time series forecasting, the artificial neural network 100 uses the dataset 90 as an input 102 to time series forecasting via a forecasting model 106), e.g. perhaps with additional information, in order to forecast future values of that input series 102 as an output series 104.

It is recognised that the dataset 90 can have implict/inherent constituent parts present in the observation/time components, such as but not limited to: 1) level, the baseline value for the series if it were a straight line; trend, the optional and often linear increasing or decreasing behavior of the series over time; seasonality, the optional repeating patterns or cycles of behavior over time; and noise, the optional variability in the observations that cannot be explained by the model. For example, all time series datasets 90 can have a level, most have noise, and the trend and seasonality can be optional. Further, it is recognised that features of many time series datasets 90 can be trends and seasonal variations, while another feature time series datasets can be that observations close together in time tend to be correlated (serially dependent)

Referring again to FIG. 1, the forecasting model 106 can be a machine learning model type referred to as a Transformer (e.g. autoformer, informer, etc.) It is recognised that a transformer model 106 can be referred to as a deep learning model that adopts the mechanism of self-attention, differentially weighting the significance of each part of the input dataset 90. Like recurrent neural networks (RNNs), transformer models 106 can be designed to handle sequential input data. However, unlike RNNs, transformer models 106 do not necessarily process the dataset 90 in order. Rather, the attention mechanism of the transformer model 106 provides context for any position in the input sequence of the dataset 90. For example, if the input data is a natural language sentence, the transformer does not need to process the beginning of the sentence before the end. Rather, the transformer model 106 identifies the context that confers meaning to each word in the sentence. This feature allows for more parallelization than RNNs and therefore facilitates a reduction in training times for transformer models 106 as compared to RNNs. For example, transformer models 106 use an attention mechanism without an RNN, processing all tokens of the dataset 90 at the same time and calculating attention weights between them in successive layers. Since the attention mechanism only uses information about other tokens from lower layers of the dataset 90, the attention mechanism can be computed for all tokens in parallel, which can lead to improved training speed of the transformer model 106 as compared to RNNs, for example.

The transformer model 106 can also employ embedding our input 102, 105 to have the same number of features as the hidden dimension of the model 106. The embedding can consist of three parts: a value embedding, a temporal embedding, and a position embedding. We concatenate a new value 1/sᵢ−0.5 to the temporal embedding before passing it to the linear layer to emphasize the input scale. We can also sample by a factor of sᵢ from the position embedding. In addition, to provide that the transformer model 106 can distinguish between the given lookback values and the prediction of the previous steps, we can further concatenate a binary value to the series before value embedding showing if each observation is coming from the lookback window or the prediction. See the Appendix for an example of the input embedding function.

The transformer model 106 uses an encoder—decoder architecture. The encoder 106a can consist of encoding layers that process the input dataset 90 iteratively one layer after another to provide the input 102, while the decoder 106b consists of decoding layers that do the same thing to the encoder's 106a output 104. The function of each encoder 106a layer is to generate encodings that contain information about which parts of the inputs of the dataset 90 are relevant to each other. The encoder 106a passes its encodings to the next encoder 106a layer as inputs. Each decoder 106b layer does the opposite, taking all the encodings and using their incorporated contextual information to generate an output sequence 105, which is then provided as an input for the next selected higher resolution.

To provide for this, each encoder 106a and decoder 106b layer makes use of the attention mechanism. In general, for each input, attention weighs the relevance of every other input and draws from them to produce the output. Each decoder 106b layer has an additional attention mechanism that draws information from the outputs of previous decoders 106b, before the decoder 106b layer draws information from the encodings. Both the encoder 106a and decoder 106b layers can have a feed-forward neural network for additional processing of the outputs and contain residual connections and layer normalization steps, as desired. As an example embodiment, each encoder 106a can consist of two major components: a self-attention mechanism and a feed-forward neural network. The self-attention mechanism accepts input encodings from the previous encoder 106a and weighs their relevance to each other to generate output encodings. The feed-forward neural network further processes each output encoding individually. These output encodings are then passed to the next encoder 106a as its input, as well as to the decoders 106b. For example, the first encoder 106a takes positional information and embeddings of the input sequence dataset 90 as its input, rather than encodings. The positional information is utilized for the transformer model 106 to make use of the order of the sequence of the dataset 90. For example, each decoder 106b can consist of three major components: a self-attention mechanism, an attention mechanism over the encodings, and a feed-forward neural network. The decoder 106b functions in a similar fashion to the encoder 106a, but an additional attention mechanism is inserted which instead can draw relevant information from the encodings generated by the encoders 106a.

It is recognized that each iteration 101 can simply use the same encoder 106a used to process the original dataset 90. Alternatively, each stage (e.g. iteration 101) can use a respective encoder 106a—decoder 106b pair, such that the encoder 106a used at each iteration 101 can be different from the previous encoder 106a used for the previous iteration 101.

It should be recognized that the horizon window of the input 102 is selected as the lowest initial resolution of the dataset 90 (e.g. 96—see FIG. 1), as provided by a pooling function 108 (see below) used to down sample the dataset 90. Using the multi-scale iteration 101 methodology of the discussed operation of the transformer model 106, the lookback window of the output 105, generated by via an upsampling function 110 (see below), is used to transform the output 104 into the next higher (e.g. predefined) scale resolution (e.g. window length 96 to window length 192, etc.). In this manner, each output 104 is upsampled to the next higher resolution as the output 105 of the decoder 106b, such that this upsampled output 105 is used as the input for the next operational iteration of the transformer model 106. In other words, the input 102 can always be at the initial selected lowest resolution, while each of the iteration outputs 104 are successively upsampled as outputs 105 that are then used as the next input of the transformer model 106. In other words, the first output 104 is based on the input 102, while subsequent iterations of the output 104 are based on the upsampled output 105. This can also be referred to as multi-scale prediction windows. For example, table 1 shows various different scales from lowest to highest resolution of the dataset 90, namely 96, 192, 336 and 720. It is recognised that the highest resolution can b the same as the original resolution of the dataset 90 (e.g. before any downsampling is performed by the pooling function 108).

Like the first encoder 106a, the first decoder 106b takes positional information and embeddings of the output sequence 104 as its input, rather than encodings. The transformer model 106 does not use the current or future output to predict an output, so the output sequence can be partially masked to inhibit this reverse information flow. The last decoder 106b is followed by a final linear transformation and softmax layer, to produce the output probabilities 104 over the dataset 90.

Also included in the network 100 is the pooling function 108, e.g. a pooling layer, used to reduce (e.g. downsample) the temporal size of the input series of the dataset 90, so that number of computations in the network 100 can be reduced. For example, pooling 108 performs downsampling by reducing the size of the series dataset 90 and sends only the considered relevant data to the next layers in the transformer model 106. For example, the pooling function 108 is used to select the initial scale resolution (e.g., 96—see table 1) of the dataset 90 (e.g. as a defined horizon window) that takes the dataset 90 and partitions it into subsections.

Also included in the network 100 is an upsampling function 110, which is used to upsample to the next higher scale resolution of the output 104. For example, the upsampling function 110 can upscale the output 104 from the resolution 96 to the resolution 192, and then the output 104 from the resolution 196 to the resolution 336, and then the output 104 from the resolution 336 to the resolution 720. For example, each of the rows of the table 1 represent the results of one individual operational of the network 106, such that row 96 represents one iteration 101 of the network 106, row 192 represents two iterations 101, row 336 represents three iterations 101 and row 720 represents four iterations 101, as discussed above.

Also included in the network 100 can be a normalization function 112, used to process the output 105 of the decoder using a (e.g zero-mean) normalization, as further described below. It is recognised that this function 112 can be optional. For example, the normalization function 112 can be used only on the input 102 and not on any of the output 105. For example, the normalization function 112 can be used on the input 102 and on each of the output 105. For example, the normalization function 112 can not be used on the input 102 and instead on one or more of the output 105.

Also included in the network 100 can be a loss function 114, used to process the output 105 of the decoder using a selected loss function 114, as further described below. For example, the loss function 114 takes a theoretical proposition of the output 104 to a practical one. Building an accurate predictor model 106 uses constant iteration of the problem. The criteria by which a statistical model 106 is scrutinized is its performance—how accurate the model's 106 decisions are, by way of the loss function 114, which calculates how far a particular iteration output 104 of the model 106 is from the actual values (e.g. of the dataset 90). In particular, the loss function 114 measures how far an estimated value output 104 is from its true value. The loss function 114 can be thought of as maping decisions to their associated costs, as further discussed below. In this way, the loss function 114 operates on the output 104 to provide the output dataset 120 as the time series prediction (e.g. a generated future series based on the original dataset 90).

While the multi-scale framework 100 can reduce the error of the final prediction output 104 for the horizon window of the original input 102, we found that further changes to the loss function 114 can also be effective in the final results output 104 of the last iteration 101. Using MSE (mean square) loss for training the model 106 can make the training process noisy in the presence of outliers. In such scenarios, using more robust loss functions such as Huber loss can improve the performance. However, in datasets 90 without significant outliers, using Huber loss can hinder the training of harder samples. Considering this, we can use adaptive loss function 114 proposed by Barron by adapting this loss function for time-series forecasting via the transformer model 106, see the Appendix for further details.

In operation of the network 100 of FIG. 1, as baselines (i.e. without iteration 101 using different resolutions) to measure the effectiveness of the proposed framework 106, we used Autoformer and Informer as two recent state-of-the-art network models on time-series forecasting. For the Informer model, we used the same model as the core of our framework 100. While, Autoformer uses a decomposition layer at the input of the decoder and does not pass the trend series to the network 100, which makes the model 106 unaware of the previous predictions in our framework 100. To help avoid this, we instead pass zeros as the trend and the series without decomposition as the input to the decoder.

In our experiments, we used four public datasets with different characteristics to compare our framework 100 with the baselines of Table 1. Electricity Consuming Load (ECL) which collects the electricity consumption (Kwh) of 321 clients. Due to the missing data, the dataset is converted into hourly consumption of 2 years and set ‘MT 320’ as the target value. The train/val/test is 15/3/4 months. Traffic which is the hourly occupancy rate of 963 car lanes of San Francisco bay area freeways. Weather contains local climatological data for nearly 1,600 U.S. locations, 4 years from 2010 to 2013, where data points are collected every 1 hour. Each data point consists of the target value “wet bulb” and 11 climate features. The train/val/test is 28/10/10 months. Exchange-Rate represents the collection of the daily exchange rates of eight foreign countries including Australia, British, Canada, Switzerland, China, Japan, New Zealand and Singapore ranging from 1990 to 2016.

In comparison with the baselines, Table 1A shows the results of the final iteration output 104 of the framework 100 and the loss function 114 (as Autoformer-MSA representing dataset 90 processed using iterations 101 described above and Informer-MSA representing dataset 90 processed using iterations 101 described above) as compared with the baselines (entitled Autoformer and Informer). As shown, the loss function 114 using the mean square error (MSE) and the mean average error (MAE) are presented. To have a better comparison, each experiment is repeated 5 times and the average is reported. Our operation of the multiscale framework 100 improved the baselines in almost all of the experiments and some cases such as exchange-rate dataset with Informer as the baseline it achieves more than 50% improvement.

Table 1A: Comparison of the MSE and MAE results for the multi-scale framework 100 version of Informer model 106 and Autoformer model 106 with their original models as the baseline. Bold numbers are the better one in comparison of our framework 100 and the baseline version. See Table 1A below.

| Dataset | | Autoformer | | Autoformer-MSA | | Informer | | Informer-MSA | |
|---|---|---|---|---|---|---|---|---|---|
| Metric | | MSE | MAE | MSE | MAE | MSE | MAE | MSE | MAE |
| Exchange | 96 | 0.154 | 0.285 | 0.126 | 0.250 | 0.966 | 0.792 | 0.168 | 0.298 |
| | 192 | 0.356 | 0.428 | 0.253 | 0.373 | 1.088 | 0.843 | 0.427 | 0.484 |
| | 336 | 0.441 | 0.495 | 0.519 | 0.538 | 1.598 | 1.016 | 0.500 | 0.535 |
| | 720 | 1.118 | 0.819 | 0.928 | 0.751 | 2.679 | 1.340 | 1.017 | 0.790 |
| Weather | 96 | 0.267 | 0.334 | 0.163 | 0.226 | 0.388 | 0.435 | 0.210 | 0.279 |
| | 192 | 0.323 | 0.376 | 0.221 | 0.290 | 0.433 | 0.453 | 0.289 | 0.333 |
| | 336 | 0.364 | 0.397 | 0.282 | 0.340 | 0.610 | 0.551 | 0.418 | 0.427 |
| | 720 | 0.425 | 0.434 | 0.369 | 0.396 | 0.978 | 0.723 | 0.595 | 0.532 |
| Electricity | 96 | 0.197 | 0.312 | 0.188 | 0.303 | 0.344 | 0.421 | 0.203 | 0.315 |
| | 192 | 0.219 | 0.329 | 0.197 | 0.310 | 0.344 | 0.426 | 0.219 | 0.331 |
| | 336 | 0.263 | 0.359 | 0.224 | 0.333 | 0.358 | 0.440 | 0.253 | 0.360 |
| | 720 | 0.290 | 0.380 | 0.249 | 0.358 | 0.386 | 0.452 | 0.293 | 0.390 |
| Traffic | 96 | 0.628 | 0.393 | 0.567 | 0.350 | 0.748 | 0.426 | 0.597 | 0.369 |
| | 192 | 0.634 | 0.401 | 0.589 | 0.360 | 0.772 | 0.436 | 0.655 | 0.399 |
| | 336 | 0.619 | 0.385 | 0.619 | 0.383 | 0.868 | 0.493 | 0.761 | 0.455 |
| | 720 | 0.656 | 0.403 | 0.642 | 0.397 | 1.074 | 0.606 | 0.924 | 0.521 |

Table 1B is shown below, provided as further results of the method 200.

| | | Method | | | | | | | | | | |
|---|---|---|---|---|---|---|---|---|---|---|---|---|
| | | FEDformer | | FED-MSA | | Autoformer | | Auto-MSA | | Informer | | Info-MSA |
| Dataset | | MSE | MAE | MSE | MAE | MSE | MAE | MSE | MAE | MSE | MAE | MSE |
| Exchange | 96 | 0.155 | 0.285 | 0.109 | 0.240 | 0.154 | 0.285 | 0.126 | 0.259 | 0.966 | 8.792 | 0.168 |
| | 192 | 0.274 | 0.384 | 0.241 | 0.353 | 0.356 | 0.428 | 0.253 | 0.373 | 1.088 | 0.842 | 0.427 |
| | 336 | 0.452 | 0.498 | 0.471 | 0.508 | 0.441 | 0.495 | 0.519 | 0.538 | 1.598 | 1.016 | 0.500 |
| | 720 | 1.172 | 0.839 | 1.259 | 0.865 | 1.118 | 0.819 | 0.928 | 0.751 | 2.679 | 1.340 | 1.017 |
| Weather | 96 | 0.288 | 0.365 | 0.220 | 0.289 | 0.267 | 0.334 | 0.163 | 0.226 | 0.388 | 0.435 | 0.210 |
| | 192 | 0.368 | 0.425 | 0.341 | 0.385 | 0.323 | 0.376 | 0.221 | 0.290 | 0.433 | 0.453 | 0.289 |
| | 336 | 0.447 | 0.469 | 0.463 | 0.455 | 0.364 | 0.397 | 0.282 | 0.340 | 0.610 | 0.551 | 0.418 |
| | 720 | 0.640 | 0.574 | 0.682 | 0.565 | 0.425 | 0.434 | 0.369 | 0.396 | 0.978 | 0.723 | 0.595 |
| Electricity | 96 | 0.201 | 0.317 | 0.182 | 0.297 | 0.197 | 0.312 | 0.188 | 0.303 | 0.344 | 0.421 | 0.203 |
| | 192 | 0.200 | 0.314 | 0.188 | 0.300 | 0.219 | 0.329 | 0.197 | 0.310 | 0.344 | 0.426 | 0.219 |
| | 336 | 0.214 | 0.330 | 0.210 | 0.324 | 0.263 | 0.359 | 0.224 | 0.333 | 0.358 | 0.440 | 0.253 |
| | 720 | 0.239 | 0.350 | 0.232 | 0.339 | 0.290 | 0.380 | 0.249 | 0.358 | 0.386 | 0.432 | 0.293 |
| Traffic | 96 | 0.601 | 0.376 | 0.564 | 0.351 | 0.628 | 0.393 | 0.567 | 0.350 | 0.748 | 0.426 | 0.597 |
| | 192 | 0.603 | 0.379 | 0.570 | 0.349 | 0.634 | 0.401 | 0.589 | 0.360 | 0.772 | 0.436 | 0.655 |
| | 336 | 0.602 | 0.375 | 0.576 | 0.349 | 0.619 | 0.385 | 0.609 | 0.383 | 0.868 | 0.493 | 0.761 |
| | 720 | 0.615 | 0.378 | 0.602 | 0.360 | 0.656 | 0.403 | 0.642 | 0.397 | 1.074 | 0.606 | 0.924 |
| ILI | 96 | 3.025 | 1.189 | 2.745 | 1.075 | 3.862 | 1.370 | 3.370 | 1.213 | 5.402 | 1.581 | 3.742 |
| | 192 | 3.034 | 1.201 | 2.748 | 1.072 | 3.871 | 1.379 | 3.088 | 1.164 | 5.296 | 1.587 | 3.807 |
| | 336 | 2.444 | 1.041 | 2.793 | 1.059 | 2.891 | 1.138 | 3.207 | 1.153 | 5.226 | 1.569 | 3.940 |
| | 720 | 2.686 | 1.112 | 2.678 | 1.071 | 3.164 | 1.223 | 2.954 | 1.112 | 5.304 | 1.578 | 3.670 |
| Vs Ours | | | | 5.6% | 5.9% | | | 13.5% | 9.1% | | | 38.5% |

| | | Method | | | | | | | | |
|---|---|---|---|---|---|---|---|---|---|---|
| | | Info-MSA | Reformer | | Ref-MSA | | Perfomer | | Per-MSA | |
| Dataset | | MAE | MSE | MAE | MSE | MAE | MSE | MAE | MSE | MAE |
| Exchange | 96 | 0.298 | 1.063 | 0.826 | 0.182 | 0.311 | 0.667 | 0.669 | 0.179 | 0.305 |
| | 192 | 0.484 | 1.597 | 1.029 | 0.375 | 0.446 | 3.339 | 0.904 | 0.439 | 0.486 |
| | 336 | 0.535 | 1.712 | 1.070 | 0.605 | 0.591 | 1.081 | 0.844 | 0.563 | 0.577 |
| | 720 | 0.799 | 1.918 | 1.360 | 1.089 | 0.857 | 0.867 | 0.766 | 1.219 | 0.882 |
| Weather | 96 | 0.279 | 0.347 | 0.388 | 0.199 | 0.263 | 0.441 | 0.479 | 0.228 | 0.291 |
| | 192 | 0.333 | 0.463 | 0.469 | 0.294 | 0.355 | 0.475 | 0.501 | 0.302 | 0.357 |
| | 336 | 0.427 | 0.734 | 0.672 | 0.463 | 0.464 | 0.478 | 0.482 | 0.441 | 0.456 |
| | 720 | 0.532 | 0.815 | 0.674 | 0.493 | 0.471 | 0.563 | 0.552 | 0.817 | 0.655 |
| Electricity | 96 | 0.315 | 0.394 | 0.382 | 0.183 | 0.291 | 0.294 | 0.387 | 0.190 | 0.300 |
| | 192 | 0.331 | 0.331 | 0.409 | 0.194 | 0.304 | 0.305 | 0.400 | 0.200 | 0.310 |
| | 336 | 0.360 | 0.361 | 0.428 | 0.209 | 0.321 | 0.331 | 0.416 | 0.209 | 0.322 |
| | 720 | 0.390 | 0.316 | 0.393 | 0.234 | 0.340 | 0.304 | 0.386 | 0.228 | 0.335 |
| Traffic | 96 | 0.369 | 0.698 | 0.386 | 0.615 | 0.377 | 0.730 | 0.405 | 0.612 | 0.371 |
| | 192 | 0.399 | 0.694 | 0.378 | 0.613 | 0.367 | 0.698 | 0.387 | 0.608 | 0.368 |
| | 336 | 0.455 | 0.695 | 0.377 | 0.617 | 0.360 | 0.678 | 0.370 | 0.604 | 0.356 |
| | 720 | 0.521 | 0.692 | 0.376 | 0.638 | 0.360 | 0.672 | 0.364 | 0.634 | 0.360 |
| ILI | 96 | 1.252 | 3.961 | 1.289 | 3.534 | 1.121 | 4.806 | 1.471 | 3.437 | 1.148 |
| | 192 | 1.272 | 4.022 | 1.311 | 3.652 | 1.235 | 4.669 | 1.455 | 4.055 | 1.248 |
| | 336 | 1.272 | 4.269 | 1.340 | 3.506 | 1.168 | 4.488 | 1.371 | 4.055 | 1.248 |
| | 720 | 1.234 | 4.370 | 1.385 | 3.487 | 1.177 | 4.607 | 1.404 | 3.828 | 1.224 |
| Vs Ours | | 26.7% | | | 38.3% | 23.2% | | | 23.3% | 16.9% |

For example, Table 1B shows Comparison of the MSE and MAE results for our multi-scale framework 100 version of different methods (-MSA) with respective baselines. Results are given in the multi-variate setting, for different lengths of the horizon window. The best results are shown in Bold. Our method 200 can outperform vanilla version of the baselines over almost all datasets and settings. The average improvement (error reduction) is shown in numbers at the bottom with respect the base models, recognizing that Table 1B shows

with ξ=(Xᵢ^{out}−Xᵢ^{(H)}) in step i. The parameters α and c, which modulate the loss sensitivity to outliers, are learnt in an end-to-end fashion during training. To the best of our knowledge, this is the first time this objective has been adapted to the context of time-series forecasting.

### Operation of the Network 100

Provided below is an overview of an example embodiment of the iterative model (see Appendix for further details on the equations used for the model 106 operated by the network/framework 100). Given the lookback window of the input series χ^{L}={x₁^{t}, . . . , x_{L}^{t}|xᵢ^{t}ϵ [symbol] }, the goal is to predict the horizon window χ^{H}={x_{L+1}^{t}, . . . , x_{L+H}^{t}|xᵢ^{t}ϵ [symbol] } (as the output 104) in which L and H are respectively the length of lookback window horizon window as provided by the upsampling function 110 for each iteration 101 and the initial input 102 provided by the pooling function 108 for the input 102. Following the previous works, for passing the input 102, 105 to the transformer model 106, we consider χ_{enc}={x₁^{t}, . . . , x_{L}^{t}} as the input to the encoder 106a and we pass the half of the observations padded with zero to form χ_{dec}={x₁^{t}, . . . , x_{L/2}^{t}, 0,0, . . . , 0} as the input to the decoder 106b with the length of L/2+H. As such, the framework 100 applies successive transformer modules to iteratively refine a time-series forecast, at different temporal scales.

While current state of the art methods are all focused on improving the performance and efficiency of the attention modules, one missing direction now provided by the network 100 and associated transformer model 106 is instead improving the flexibility of the model 106 in a model agnostic way, such that successive upsampled outputs 105 are iterated 101 using the same model 106. In other words, the same model 106 is used for each of the different upsampled outputs 105, as well as for the original input 102. As such, the network 100 uses the same model 106 to predict the output 104 in different scales (such that the original input 102 and each successive output 105 are provided at increasing scale resolutions). In other words, the resolution of the output 104 for the first iteration 101 of the model 106 is the lowest resolution (e.g. 96), the next iteration 101 of the model 106 is using the output 105 upsampled to the next higher resolution (e.g. 196), the next iteration 101 of the model 106 is using the output 105 upsampled to the next higher resolution (e.g. 336), and the further iterations 101 continue to be upsampled until the final resolution of the original data set 90 (e.g. 720) is reached.

The framework 100 is shown in FIG. 1, given an input lookback window of χ^{L}, we use the same model 106 multiple times using the input 102, 105 in different resolutions (e.g. different temporal scales). Concretely, we consider a set of resolutions (e.g. a set of scales) S={s₁, . . . , sₘ,1} in which m=└Log_{C}(L)┘, sₘ=1, and sᵢ₋₁=sᵢ×C. The encoder 106a input at ith time (e.g. step) is averaged pooling of χ_{enc} with the scale sᵢ while the input 104 to the decoder 106b is upsampled version of χₒᵤₜ,sᵢ₋₁ with a scale of C. We further define χ_{out,s}_{₀}=AvgPool(χ_{dec}) for the first step. The set of resolutions being used as one resolution for each of the iterations 101, such that the resolution of a previous iteration 101 is lower than a resolution of a subsequent iteration 101. Further, we found that a factor can be to (e.g. zero-mean) normalization of the inputs 102, 105 before each pass to the model 106. An example normalization function 112 (e.g. zero-mean) is described below, for example. Given the above, it is recognized that, for example, for a default scale of s=2, S is a set of consecutive powers of 2 and s is a downscaling factor.

Given a set of input series (X_{enc,s}_{ᵢ}, X_{dec,s}_{ᵢ}) for the dataset 90, with the dimensions of L×d and H×d, respectively for the encoder 106a and the decoder 106b of the transformer model 106 in ith scale, we normalize each series based on the average of both X_{enc,s}_{ᵢ} and X_{dec,s}_{ᵢ}. More formally:

X̅ₛᵢ=AVg(X_{enc,s}_{ᵢ}⊕X_{dec,s}_{ᵢ}) (1a)

X_{dec,s}_{ᵢ}=X_{dec,s}_{ᵢ}−X̅ₛᵢ (2a)

X_{enc,s}_{ᵢ}=X_{enc,s}_{ᵢ}−X̅ₛᵢ (3a)

In the above equations, \hat{X}ₛᵢ ϵR^{d} is the average over the temporal dimension of the whole series including concatenation of both lookback window (of the upsampling function 110) and the horizon window (of the pooling function 108) lengths. A more detailed explanation and equations of the optional normalization process can be found in the Appendix, including the cross-scale normalization.

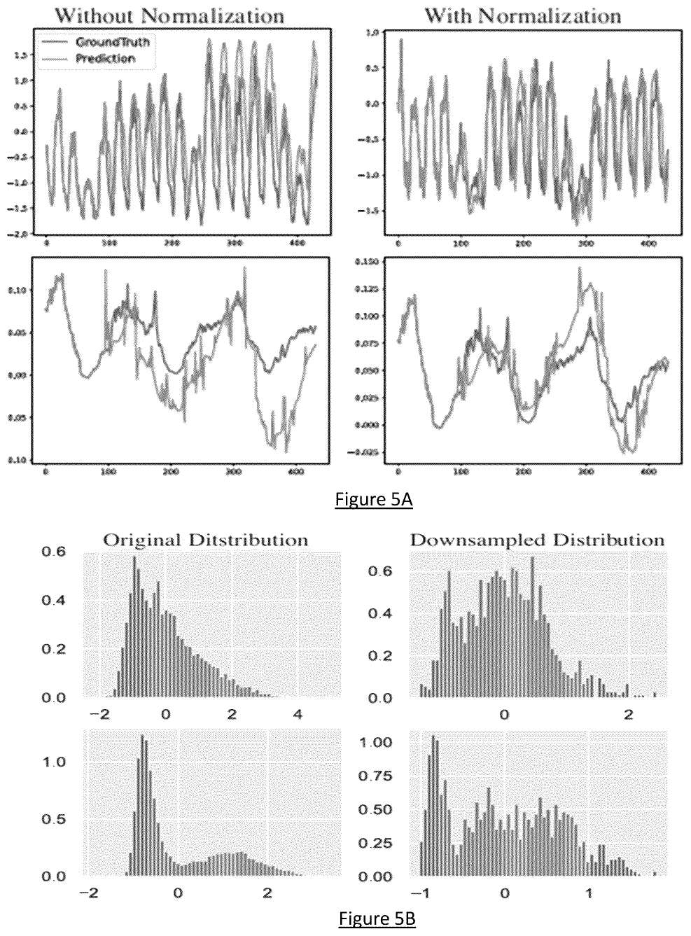

Referring to FIGS. 5A, 5B, shown are the output 120 results of two series 90 using the same trained multi-scale model method 200 with and without shifting the data (left) which demonstrates the importance of normalization. On the right (with normalization), we can see the distribution changes due to the downsampling of two series compared to the original scales from the Electricity dataset 90. It is recognized that distribution shift can be when the distribution of input to a model or its sub-components changes across training to deployment In our context of the framework 100, two distinct distribution shifts can occur. First, there can be a natural distribution shift between the look-back window and the forecast window (the covariate shift). Additionally, there can be a distribution shift between the predicted forecast windows at two consecutive scales which can be a result of the upsampling operation alongside the error accumulation during the intermediate computations. As a result, normalizing the output at a given step by either the look-back window statistics or the previously predicted forecast window statistics can result in an accumulation of errors across steps. We can mitigate potential error accumulation by considering a moving average of forecast and look-back statistics as the basis for the output normalization, which can impact the resulting distribution of outputs. The improvement based on normalization can be more evident when compared to the alternative approaches, namely, normalizing by either look-back or previous forecast window statistics.

To verify the performance improvement of both the framework 100 and the adaptive loss function 114, we trained the models 106 on all four combinations of baselines with and without multi-scale resolution iteration 101 (as discussed above) and using MSE loss or Adaptive loss functions 114 for training. Table 2 and Table 3 show the effect of multi-scale MS and loss function 114 respectively for Informer and Autoformer models 106 using the framework 100.

TABLE 2
Comparison of Informer model using multi-scale framework with mse loss
for training “-MS” and Adaptive loss “-MSA”.

| Dataset | | Informer | | Informer-MS | | Informer-MSA | |
|---|---|---|---|---|---|---|---|
| Metric | | MSE | MAE | MSE | MAE | MSE | MAE |
| Weather | 96 | 0.388 ± 0.040 | 0.435 ± 0.028 | 0.249 ± 0.016 | 0.324 ± 0.013 | 0.210 ± 0.016 | 0.279 ± 0.016 |
| | 192 | 0.433 ± 0.046 | 0.453 ± 0.033 | 0.315 ± 0.021 | 0.380 ± 0.018 | 0.289 ± 0.011 | 0.333 ± 0.005 |
| | 336 | 0.610 ± 0.035 | 0.551 ± 0.018 | 0.473 ± 0.040 | 0.478 ± 0.024 | 0.418 ± 0.039 | 0.427 ± 0.028 |
| | 720 | 0.978 ± 0.053 | 0.723 ± 0.021 | 0.664 ± 0.035 | 0.585 ± 0.017 | 0.595 ± 0.043 | 0.532 ± 0.024 |
| Electricity | 96 | 0.344 ± 0.004 | 0.421 ± 0.003 | 0.211 ± 0.003 | 0.326 ± 0.003 | 0.203 ± 0.011 | 0.315 ± 0.011 |
| | 192 | 0.344 ± 0.007 | 0.426 ± 0.006 | 0.233 ± 0.006 | 0.348 ± 0.004 | 0.219 ± 0.002 | 0.331 ± 0.003 |
| | 336 | 0.358 ± 0.008 | 0.440 ± 0.006 | 0.279 ± 0.012 | 0.388 ± 0.011 | 0.253 ± 0.008 | 0.360 ± 0.007 |
| | 720 | 0.386 ± 0.003 | 0.452 ± 0.004 | 0.315 ± 0.005 | 0.411 ± 0.004 | 0.293 ± 0.006 | 0.390 ± 0.006 |

TABLE 3
Comparison of Autoformer model using malti-scale framework with mse loss
for training “-MS” and Adaptive loss “-MSA”

| Dataset | | Autoformer | | Amoformer-MS | | Autoformer-MSA | |
|---|---|---|---|---|---|---|---|
| Metric | | MSE | MAE | MSE | MAE | MSE | MAE |
| Weather | 96 | 0.267 ± 0.031 | 0.334 ± 0.020 | 0.174 ± 0.005 | 0.254 ± 0.005 | 0.163 ± 0.008 | 0.226 ± 0.011 |
| | 192 | 0.323 ± 0.005 | 0.376 ± 0.004 | 0.250 ± 0.021 | 0.333 ± 0.022 | 0.221 ± 0.009 | 0.290 ± 0.016 |
| | 336 | 0.364 ± 0.016 | 0.397 ± 0.012 | 0.314 ± 0.018 | 0.380 ± 0.019 | 0.282 ± 0.024 | 0.340 ± 0.025 |
| | 720 | 0.425 ± 0.006 | 0.434 ± 0.005 | 0.414 ± 0.034 | 0.457 ± 0.024 | 0.369 ± 0.041 | 0.396 ± 0.032 |
| Electricity | 96 | 0.197 ± 0.005 | 0.312 ± 0.005 | 0.196 ± 0.004 | 0.312 ± 0.005 | 0.188 ± 0.004 | 0.303 ± 0.005 |
| | 192 | 0.219 ± 0.006 | 0.329 ± 0.005 | 0.208 ± 0.003 | 0.323 ± 0.003 | 0.197 ± 0.003 | 0.310 ± 0.003 |
| | 336 | 0.263 ± 0.040 | 0.359 ± 0.025 | 0.220 ± 0.003 | 0.336 ± 0.004 | 0.224 ± 0.020 | 0.333 ± 0.012 |
| | 720 | 0.290 ± 0.046 | 0.380 ± 0.024 | 0.252 ± 0.004 | 0.364 ± 0.002 | 0.249 ± 0.009 | 0.358 ± 0.007 |

Table 2A shows Multi-scale framework without cross-scale normalization. Correctly normalizing across different scales (as per our cross-mean normalization) can be used to obtain improved performance when using the multi-scale framework 100.

| Dataset | | FEDformer | | FED-MS (w/o N) | | Autoformer | | Auto-MS (w/o N) | | Informer | | Info-MS (w/o N) | |
|---|---|---|---|---|---|---|---|---|---|---|---|---|---|
| Matric | | MSE | MAE | MSE | MAE | MSE | MAE | MSE | MAE | MSE | MAE | MSE | MAE |
| Weather | 96 | 0.288 | 0.365 | 0.300 | 0.342 | 0.267 | 0.334 | 0.191 | 0.277 | 0.388 | 0.435 | 0.402 | 0.438 |
| | 192 | 0.368 | 0.425 | 0.424 | 0.422 | 0.323 | 0.376 | 0.281 | 0.360 | 0.433 | 0.453 | 0.393 | 0.434 |
| | 336 | 0.447 | 0.469 | 0.531 | 0.493 | 0.364 | 0.397 | 0.376 | 0.420 | 0.610 | 0.551 | 0.566 | 0.528 |
| | 720 | 0.640 | 0.574 | 0.714 | 0.576 | 0.425 | 0.434 | 0.439 | 0.465 | 0.978 | 8.723 | 1.293 | 0.845 |
| Electricity | 96 | 0.201 | 0.317 | 0.258 | 0.356 | 0.197 | 0.312 | 0.221 | 0.337 | 0.344 | 8.421 | 0.407 | 0.465 |
| | 192 | 0.200 | 0.314 | 0.259 | 0.357 | 0.219 | 0.329 | 0.251 | 0.357 | 0.344 | 8.426 | 0.407 | 0.469 |
| | 336 | 0.214 | 0.330 | 0.268 | 0.364 | 0.263 | 0.359 | 0.288 | 0.380 | 0.358 | 0.440 | 0.392 | 0.461 |
| | 720 | 0.239 | 0.350 | 0.285 | 0.368 | 0.290 | 0.380 | 0.309 | 0.397 | 0.386 | 0.452 | 0.391 | 0.453 |

Table 3A shows a single-scale framework with cross scale normalization “-N”. The cross-scale normalization (which in the single-scale case corresponds to mean-normalization of the output) does not improve the performance of the Autoformer, as it already has an internal trend-cycle normalization component. However, it does improve the results of the Informer and FEDformer.

| Dataset | | FEDformer | | FEDformer-N | | Autoformer | | Autoformer-N | | Informer | | Informer-N | |
|---|---|---|---|---|---|---|---|---|---|---|---|---|---|
| Metric | | MSE | MAE | MSE | MAE | MSE | MAE | MSE | MAE | MSE | MAE | MSE | MAE |
| Wenther | 96 | 0.288 | 0.365 | 0.234 | 0.292 | 0.267 | 0.334 | 0.323 | 0.401 | 0.388 | 0.435 | 0.253 | 0.333 |
| | 192 | 0.368 | 0.425 | 0.287 | 0.337 | 0.323 | 0.376 | 0.531 | 0.543 | 0.433 | 0.453 | 0.357 | 0.408 |
| | 336 | 0.447 | 6.469 | 0.436 | 0.443 | 0.364 | 0.397 | 0.859 | 0.708 | 0.610 | 0.551 | 0.459 | 0.461 |
| | 720 | 0.640 | 0.574 | 0.545 | 0.504 | 0.425 | 0.434 | 1.682 | 1.028 | 0.978 | 0.723 | 0.870 | 0.676 |
| Electricity | 96 | 0.201 | 0.317 | 0.194 | 0.307 | 0.197 | 0.312 | 0.251 | 0.364 | 0.344 | 0.421 | 0.247 | 0.356 |
| | 192 | 0.200 | 0.314 | 0.195 | 0.304 | 0.219 | 0.329 | 0.263 | 0.372 | 0.344 | 0.426 | 0.291 | 0.394 |
| | 336 | 0.214 | 0.330 | 0.200 | 0.310 | 0.263 | 0.359 | 0.276 | 0.388 | 0.358 | 0.440 | 0.321 | 0.416 |
| | 720 | 0.239 | 0.350 | 0.225 | 0.332 | 0.290 | 0.380 | 0.280 | 0.385 | 0.386 | 0.452 | 0.362 | 0.434 |

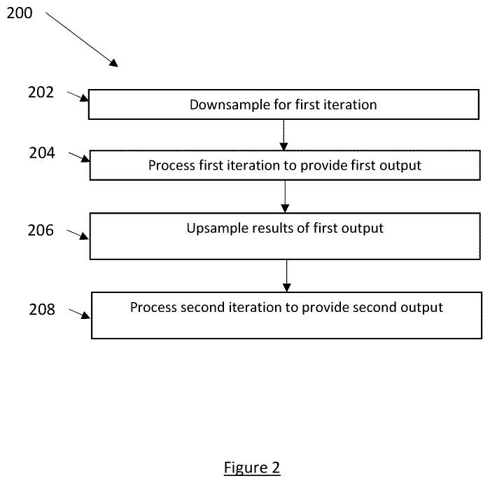

Referring to FIG. 2, shown is an example operation 200 of the network 100 of FIG. 1, operating the neural network 100 using a (e.g. transformer) model 106 to provide a time series forecast 104, recognising that the forecasting model 106 uses an encoder—decoder architecture. At step 202, down sampling a time series dataset 90 to generate an initial input 102 having a first scale resolution, such that the first scale resolution is less than a scale resolution of the time series dataset 90. At step 204, processing as a first iteration, using the transformer model 106, the initial input 102 to generate a first output 104, the first output 104 representing a time series forecast of the time series dataset 90 at the scale resolution of the initial input 102. At step 206, upsampling by an upsampling function 110 the first output 104 to generate a second input 105 having a second scale resolution, the second scale resolution being higher than the first scale resolution, such that the second input 105 is based on the first output 104. At step 208, processing as a second iteration, using the transformer model 106, the second input 105 to generate a second output 104, the second output 104 representing a time series forecast of the time series dataset 90 at the scale resolution of the second input 105.

An example Algorithm 1 of the method 200 can be as follows, using the equations provided in the Appendix for example.

Algorithm 1 Scaleformer: Iterative Multi-scale Refining Transformer

```
Require: input lookback window X^{(L)} ∈ [symbol] , scale factor s,
    a set of scales S = {s^{m}, . . . , s², s¹, 1}, Horizon length [symbol] , and Transformer module F.
  for i ← 0 to m do
```

| | |
|---|---|
| Xᵢ^{enc} ← AvgPool (X^{(L)}, window_size = s^{m-i}) | [symbol] Equation (1) and (2) of the paper |

```
    if i = 0 then
      Xᵢ^{dec} ← [ [symbol]  ]
    else
```

| | |
|---|---|
| Xᵢ^{dec} ← Upsample (Xᵢ₋₁^{out}, scale = s) | [symbol] Equation (5) and (6) of the paper |

```
    end if
    $\overline{μ} {x}_{i} ← \frac{1}{{ℓ}_{L , i} + {ℓ}_{H , i}} ( {\sum }_{{x}^{enc} ∈ {X}_{i}^{enc}} {x}^{enc} + {\sum }_{{x}^{dec} ∈ {X}_{i}^{dec}} {x}^{dec} )$
    \hat{X}ᵢ^{dec} ← Xᵢ^{dec} − μ̅_{X}_{ᵢ}
    \hat{X}ᵢ^{enc} ← Xᵢ^{enc} − μ̅_{X}_{ᵢ}
    Xᵢ^{out} ← F (Xᵢ^{enc}, Xᵢ^{dec}) + μ̅_{X}_{ᵢ}
  end for
```

| | |
|---|---|
| Ensure: Xᵢ^{out} | [symbol] return the prediction at all scales |

As provided above with respect to the Tables and plots, example datasets 90 used included four public datasets with different characteristics to evaluate the framework 100. Electricity Consuming Load (ECL) corresponds to the electricity consumption (Kwh) of 321 clients. Traffic aggregates the hourly occupancy rate of 963 car lanes of San Francisco bay area freeways. Weather contains 21 meteorological indicators, such as air temperature, humidity, etc, recorded every 10 minutes for the entirety of 2020. Exchange-Rate collects the daily exchange rates of 8 countries (Australia, British, Canada, Switzerland, China, Japan, New Zealand and Singapore) from 1990 to 2016. National Illness (ILI) corresponds to the weekly recorded influenza-like illness patients from the US Center for Disease Control and Prevention. We consider horizon lengths of 24, 32, 48, and 64 with an input length of 32.

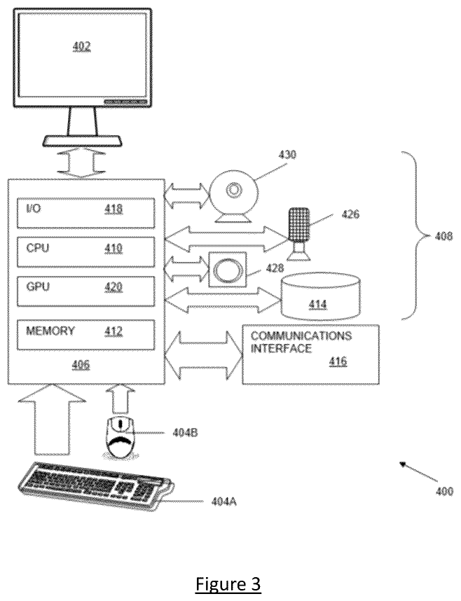

An example computer system, for implementing the framework 100 and method 200, in respect of which the technology herein described can be implemented is presented as a block diagram in FIG. 3. The example computer system is denoted generally by reference numeral 400 and includes a display 402, input devices in the form of keyboard 404A and pointing device 404B, computer 406 and external devices 408. While pointing device 404B is depicted as a mouse, it will be appreciated that other types of pointing device, or a touch screen, may also be used.

The computer 406 may contain one or more processors or microprocessors for implementing the method 200 of the framework 100, such as a central processing unit (CPU) 410. The CPU 410 performs arithmetic calculations and control functions to execute software stored in a non-transitory internal memory 412, preferably random access memory (RAM) and/or read only memory (ROM), and possibly additional memory 414. The additional memory 414 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 414 may be physically internal to the computer 406, or external as shown in FIG. 3, or both. The additional memory 414 may also comprise a database for storing training data to train the network 100 and/or method 200, or that the network 100 and/or method 200 can retrieve and use for inference after training. For example, the datasets 90 used in the experiments described above may be stored in such a database and retrieved for use in training.

The one or more processors or microprocessors may comprise any suitable processing unit such as an artificial intelligence accelerator, programmable logic controller, a microcontroller (which comprises both a processing unit and a non-transitory computer readable medium), AI accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal and/or additional memory 414 for execution by the one or more processors or microprocessors to effect neural network pre-training, training, or use of a trained network for inference.

The computer system 400 may also include other similar means for allowing computer programs or other instructions to be loaded (e.g. the model 106 and associated method 200 instructions). Such means can include, for example, a communications interface 416 which allows software and data to be transferred between the computer system 400 and external systems and networks. Examples of communications interface 416 can include a modem, a network interface such as an Ethernet card, a wireless communication interface, or a serial or parallel communications port. Software and data transferred via communications interface 416 are in the form of signals which can be electronic, acoustic, electromagnetic, optical or other signals capable of being received by communications interface 416. Multiple interfaces, of course, can be provided on a single computer system 400.

Input and output to and from the computer 406 is administered by the input/output (I/O) interface 418. This I/O interface 418 administers control of the display 402, keyboard 404A, external devices 408 and other such components of the computer system 400. The computer 406 also includes a graphical processing unit (GPU) 420. The latter may also be used for computational purposes as an adjunct to, or instead of, the (CPU) 410, for mathematical calculations.

The external devices 408 include a microphone 426, a speaker 428 and a camera 430. Although shown as external devices, they may alternatively be built in as part of the hardware of the computer system 400. For example, the camera 430 and microphone 426 may be used to retrieve multi-modal video content for use to train the network 100 and/or method 200, or for processing by a trained network 100 or trained method 200.

The various components of the computer system 400 are coupled to one another either directly or by coupling to suitable buses. The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

In view of the above, it is recognized that the example network 100 and associated method 200 provide the following: (1) a novel iterative scale-refinement paradigm that can be readily adapted to a variety of encoder-based (e.g. transformer) time series forecasting architectures; (2) minimize potential distribution shifts between scales and windows by introducing cross-scale normalization on outputs of the model 106 at one or more of the iterative steps/scales; (3) using Informer and AutoFormer, two state-of-the-art transformer architectures as backbones, we demonstrate empirically the effectiveness of the method 200 on a variety of datasets. Therefore, depending on the choice of model 106 architecture, our multi-scale framework 100 can result in mean squared error reductions ranging from 5:5% to 38:5%; and (4) via a detailed ablation study of our findings, we demonstrate the validity of our architectural and methodological choices.

The above presented framework 100 and method 200 have been shown to be beneficial when applied to transformer-based, deterministic time series forecasting. However, the framework 100 and method 200 are not limited to those settings, rather the framework 100 and method 200 can be extended to probabilistic forecasting and non transformer-based encoders 106a,b, both of which are closely coupled with our primary application. It is recognized that what is common for the various described applications of the framework 100 and method 200 is that the forecasting model 106 (e.g. transformer based, non transformer based, etc.) uses an encoder-decoder architecture.

For example, we show that our above presented framework 100 and method 200, using multiscale encoding 106a,b, can improve performance in a probabilistic forecasting setting (please refer to Tables 4, 5 below for example results). We adopt the probabilistic output of DeepAR (Salinas et al., 2020), which is the most common probabilistic forecasting treatment. In this setting, instead of a point estimate, we have two prediction heads models 106, predicting the mean and standard deviation, trained with a negative log likelihood loss (NLL). NLL and continuous ranked probability score (CRPS) are used as evaluation metrics. All other hyperparameters remain unchanged. Here, again, the operation of the framework 100 and method 200 applied to the non transformer based models 106 continue to outperform the probabilistic

Informer.

While we have mainly focused on improving transformer-based models 106, they are not the only encoders 106a,b. Recent models such as NHits (Challu et al., 2022) and FiLM (Zhou et al., 2022a) attain competitive performance, while assuming a fixed length univariate input/output. They can be less flexible compared with variable length of multi-variate input/output, but result in strong performance and faster inference than transformers, making them interesting to consider. The application of the framework 100 and method 200 demonstrates a statistically significant improvement, on average, when adapted by NHits and FiLM based models 106 to iteratively refine predictions.

The results mentioned above demonstrate that framework 100 and method 200 can adapt to settings distinct from point-wise time-series forecasts with transformers, such as probabilistic forecasts and non-transformer models.

Table 4 shows the comparison of probabilistic methods for Informer by following the probabilistic output of DeepAR (Salinas et al., 2020), which is the most common probabilistic forecasting treatment.

| Dataset | | 96 | | 192 | | 336 | | 720 | |
|---|---|---|---|---|---|---|---|---|---|
| Metric | | CRPS | NLL | CRPS | NLL | CRPS | NLL | CRPS | NLL |
| Exchange | Informer | 0.548 ± 0.02 | 2.360 ± 0.20 | 0.702 ± [symbol] | 4.350 ± 1.45 | 0.826 ± 0.02 | 4.302 ± 0.49 | 1.268 ± 0.06 | 13.140 ± 1.84 |
| | Informer-MSA | 0.202 ± 0.01 | 0.452 ± 0.0 [symbol] | 0.284 ± 0.02 | 0.818 ± 0. [symbol] | 0.414 ± 0.06 | 1.724 ± 0.43 | 0.570 ± 0.03 | 2.210 ± 0.21 |
| Weather | Informer | 0.376 ± 0.03 | 1.180 ± 0.21 | 0.502 ± [symbol] | 1.752 ±0.23 | 0.564 ± 0.02 | 1.928 ± 0.27 | 0.684 ± 0.09 | 2.210 ± 0.46 |
| | Informar-MSA | 0.250 ± 0.02 | 0.392 ± 0. [symbol] | 0.294 ± 0.01 | 0.610 ± 0.04 | 0.308 ± 0.02 | 0.728 ± 0. [symbol] | 0.438 ± 0.04 | 1.270 ± 0.14 |
| Electricity | Informer | 0.330 ± 0.01 | 1.106 ± 0.0 [symbol] | 0.338 ± 0.03 | 1.254 ± 0.04 | 0.348 ± 0.01 | 1.244 ± 0.07 | 0.528 ± 0.00 | 1.856 ± 0.06 |
| | Informer-MSA | 0.238 ± 0.01 | 0.578 ± 0.01 | 0.290 ± [symbol] | 0.776 ± 0.01 | 0.324 ± 0.03 | 0.904 ± 0.10 | 0.358 ± 0.01 | 1.022 ± 0.04 |
| Traffic | Informer | 0.372 ± 0.04 | 1.376 ± 0.0 [symbol] | 0.340 ± 0.01 | 1.404 ± 0.04 | 0.372 ± 0.01 | 1.516 ± 0.06 | 0.568 ± 0.01 | 1.658 ± 0.01 |
| | Informer-MSA | 0.288 ± 0.01 | 1.094 ± 0.0 [symbol] | 0.312 ± 0.01 | 1.102 ± 0.04 | 0.368 ± 0.02 | 1.194 ± 0.05 | 0.442 ± 0.02 | 1.378 ± 0.06 |

[symbol]

indicates data missing or illegible when filed

Table 5 shows the comparison results of NHiTs (Challu et al., 2022) and FiLM (Zhou et al., 2022a) as two baselines. For each method, we copy original model to have model for different scales and we concatenate the input with the output of previous scale for the new scale. The training hyperparameters such as optimizer and learning rate is the same as the previous baselines. The shown effect of applying our proposed framework to NHits and FiLM as two non-transformer based models. Best results are shown in Bold.

| Dataset | | NHITS | | NHITS-MSA | | FILM | | FILM MSA | |
|---|---|---|---|---|---|---|---|---|---|
| Metric | | MSE | MAE | MSE | MAE | MSE | MAE | MSE | MAR |
| Exchange | 96 | 0.091 ± 0.00 | 0.218 ± 0.01 | 0.087 ± 0.0 [symbol] | 0.206 ± 0.00 | 0.083 ± 0.00 | 0.201 ± 0.0 [symbol] | 0.081 ± 0.00 | 0.197 ± 0.00 |
| | 192 | 0.200 ± 0.02 | 0.332 ± 0.01 | 0.186 ± 0.01 | 0.306 ± 0.00 | 0.179 ± 0.00 | 0.301 ± 0.00 | 0.156 ± 0.00 | 0.284 ± 0.00 |
| | 336 | 0.347 ± 0.03 | 0.442 ± 0.02 | 0.381 ± 0.01 | 0.445± 0. [symbol] | 0.341 ± 0.00 | 0.421 ± 0.00 | 0.253 ± 0.00 | 0.378 ± 0.0 [symbol] |
| | 720 | 0.761 ± 0.20 | 0.662 ± 0.0 [symbol] | 1.124 ± 0.07 | 0.808 ± 0. [symbol] | 0.896 ± 0.01 | 0.714 ± 0.00 | 0.728 ± 0.01 | 0.659 ± 0.00 |
| Weather | 96 | 0.169 ± 0.00 | 0.228 ± 0 [symbol] | 0.167 ± 0.00 | 0.211 ± 0.00 | 0.194 ± 0.00 | 0.235 ± 0.00 | 0.195 ± 0.00 | 0.232 ± 0.00 |
| | 192 | 0.210 ± 0.00 | 0.268 ± 0 [symbol] | 0.208 ± 0.00 | 0.253 ± 0.00 | 0.238 ± 0.00 | 0.270 ± 0.00 | 0.235 ± 0.00 | 0.269 ± 0.00 |
| | 336 | 0.261 ± 0.00 | 0.313 ± 0 [symbol] | 0.261 ± 0.00 | 0.294 ± 0.00 | 0.288 ± 0.00 | 0.305 ± 0.00 | 0.275 ± 0.00 | 0.303 ± 0.00 |
| | 720 | 0.333 ± 0.01 | 0.372 ± 0 [symbol] | 0.331 ± 0.00 | 0.348 ± 0.00 | 0.359 ± 0.00 | 0.350 ± 0.00 | 0.337 ± 0.00 | 0.356 ± 0.00 |

[symbol]

indicates data missing or illegible when filed

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

### Appendix of Example Method 200 Using the Framework 100

We denote X_{(L)} and X^{(H)} the look-back and horizon windows for the for respectively, of corresponding lengths [symbol] _{L}, [symbol] _{H}. Given a starting time tₒ we can express these time-series of dimension dₓ, as follows: X^{(L)}={xₜ|xᵢϵ [symbol] , tϵ[t₀, t₀+ [symbol] _{L}|} and X^{(H)}={xₜ|xᵢϵ [symbol] , tϵϵt₀+ [symbol] _{L}+1, t₀+ [symbol] _{L}+ [symbol] _{H}]}. The gOal of the forecasting task is to predict the, horizon window X^{(H)} given the load-back window X^{(L)}.

Given an input time-series X^{(L)}, we iteratively apply the same neural module multiple times at different temporal scales. Concretely, we consider a set of scales S={s^{m}, . . . , s², s³, 1} (i.e. for the default scale of s=2, S is a set of consecutive powers of 2), where m=└logₛ [symbol] _{L} ┘−1 and s is a downscaling factor. The input to the encoder at the i-th step (0≤i≤m) is the original look-back window X^{(L)}, downsampled by a scale factor of sᵢ∝s^{m-i} via an average pooling operation. The input to the decoder, on the other hand, is Xᵢ₋₁^{out} upsampled by a factor of s via a linear interpolation.

Finally, X₀^{dec} is initialized to an array of 0s. The model performs the following operations:

$${x}_{t , i} = \frac{1}{{s}_{i}} {\sum }_{τ + 1}^{τ + {s}_{i}} {x}_{τ} , τ = t \times {s}_{i} \qquad ( 1 )$$

$${X}_{i}^{( L )} = \{ {x}_{t , i} \vert \frac{{t}_{0}}{{s}_{i}} \leq t \leq \frac{{t}_{0} + {ℓ}_{L}}{{s}_{i}} \} \qquad ( 2 )$$

$${X}_{i}^{( H )} = \{ {x}_{t , i} \vert \frac{{t}_{0} + {ℓ}_{L} + 1}{{s}_{i}} \leq t \leq \frac{{t}_{0} + {ℓ}_{L} + {ℓ}_{H}}{{s}_{i}} \} , \qquad ( 3 )$$

where Xᵢ^{(L)} and Xᵢ^{(H)} are the look-back and horizon windows at the ith step at time t with the scale factor of s^{m-i} and with the lengths of [symbol] _{L,t} and [symbol] _{H,i}, respectively. Assuming x′_{t,t-1} is the output of the forecasting module at step i−1 and time t, we can define Xᵢ^{enc} and Xᵢ^{dec} as the inputs to the normalization:

$${X}_{i}^{enc} = {X}_{i}^{( L )} \qquad ( 4 )$$

$${x}_{t , i}^{″} = {x}_{⌊ t / s ⌋ , i - 1}^{′} + {x}_{⌈ t / s ⌉ , i - 1}^{′} - {x}_{⌊ t / s ⌋ , i - 1}^{′} ) \times \frac{t - ⌊ t / s ⌋}{s} \qquad ( 5 )$$

$${X}_{i}^{dec} = \{ {x}_{i , t}^{″} \vert \frac{{t}_{0} + {ℓ}_{L} + 1}{{s}_{i}} \leq t \leq \frac{{t}_{0} + {ℓ}_{L} + {ℓ}_{H}}{{s}_{i}} \} . \qquad ( 6 )$$

Finally, we calculate the error between Xᵢ^{(H)} and Xᵢ^{out} as the loss function to train the model. Please refer to Algorithm 1 for details on the sequence of operations performed during the forward pass.

Given a set of input series (Xᵢ^{enc}, Xᵢ^{dec}), with dimensions [symbol] _{L}_{ᵢ}×dₓ and [symbol] _{H}_{ᵢ}_{×d}_{ₓ}, respectively for the encoder and the decoder of the transformer in ith step, we normalize each series based on the temporal average of Xᵢ^{enc} and Xᵢ^{dec}. More formally:

$${\overline{μ}}_{{X}_{i}} = \frac{1}{{ℓ}_{L , i} + {ℓ}_{H , i}} ( {\sum }_{{x}^{enc} ∈ {X}_{i}^{enc}} {x}^{enc} + {\sum }_{{x}^{dec} ∈ {X}_{i}^{dec}} {x}^{dec} ) \qquad ( 7 )$$

$${\hat{X}}_{i}^{dec} = {X}_{i}^{dec} - {\overline{μ}}_{{X}_{i}} , {\hat{X}}_{i}^{enc} = {X}_{i}^{enc} - {\overline{μ}}_{X} . \qquad ( 8 )$$

where μ̅xᵢϵ [symbol] is the average over the temporal dimension of the concatenation of both look-back window and the horizon. Here, \hat{X}ᵢ^{enc} and \hat{X}ᵢ^{dec} are the inputs of the ith step to the forecasting module.

Following the previous works, we embed our input to have the same number of features as the hidden dimension of the model. The embedding consists of three parts: (1) Value embedding which uses a linear layer to map the input observations of each step xₜ to the same dimension as the model. We further concatenate an additional value 0, 0.5, or 1 respectively showing if each observation is coming from the look-back window, zero initialization, or the prediction of the previous steps. (2) Temporal Embedding which again uses a linear layer to embed the time stamp related to each observation to the hidden dimension of the model. Here we concatenate an additional value 1/sᵢ−0.5 as the current scale for the network before passing to the linear layer. (3) We also use a fixed positional embedding which is adapted to the different scales s, as follows:

$$PE ( pos , 2 k , {s}_{i} ) = sin ( \frac{pos \times {s}_{i}}{{10000}^{2 k / d} \text{?}} ) . \\ PE ( pos , 2 k + 1 , {s}_{i} ) = cos ( \frac{pos \times {s}_{i}}{{10000}^{2 k / d} \text{?}} ) \qquad ( 9 )$$

$$\text{?} \text{indicates text missing or illegible when filed}$$

Using the standard MSE objective to train time-series forecasting models leaves them sensitive to outliers. One possible solution is to use objectives more robust to outliers, such as the Huber loss (Huber, 1964). However, when there are no major outliers, such objectives tend to underperform. Given the heterogeneous nature of the data, we instead utilize the adaptive loss (Barron, 2019):

$$f ( ξ , α , c ) = \frac{\vert α - 2 \vert}{α} ( {( \frac{{( ξ / c )}^{2}}{\vert α - 2 \vert} + 1 )}^{α / 2} - 1 ) \qquad ( 10 )$$

Implementation details: Following previous work (Xu et al., 2021; Zhou et al., 2021), we pass X^{enc}=X^{(L)} as the input to the encoder. While an array of zero-values would be the default to pass to the decoder, the decoder instead takes as input the second half of the look-back window padded with zeros X^{dec}={ [symbol] _{/2}, . . . , [symbol] , 0, 0, . . . , 0} with length [symbol] _{L}/2+ [symbol] ^{H}. The hidden dimension of models is 512 with a batch size of 32. We use the Adam optimizer with a learning rate of 1e-4. The look-back window size is fixed to 96, and the horizon is varied from 96 to 720. We repeat each experiment 5 times and report average values to reduce randomness. For additional implementation

1. A method for operating a neural network using an encoder-based model to provide a time series forecast, the method comprising:
down sampling a time series dataset to generate an initial input having a first scale resolution, such that the first scale resolution is less than a scale resolution of the time series dataset;
processing as a first iteration, using the model, the initial input to generate a first output;
upsampling by an upsampling function the first output to generate a second input having a second scale resolution, the second scale resolution being higher than the first scale resolution, such that the second input is based on the first output; and
processing as a second iteration, using the model, the second input to generate a second output;
wherein the second output represents a time series forecast of the time series dataset.

2. The method of claim 1 further comprising continuing to iterate using one or more subsequent iterations using the model and the upsampling function until a resolution scale of the time series forecast matches the scale resolution of the time series dataset.

3. The method of claim 1, wherein a resolution scale of the time series forecast matches the scale resolution of the time series dataset.

4. The method of claim 1 further comprising using a same encoder for each of the first iteration and the second iteration.

5. The method of claim 1 further comprising using a different encoder for each of the first iteration and the second iteration.

6. The method of claim 1 further comprising using a normalization function on the initial input in order to normalize the initial input before said processing using the model.

7. The method of claim 1 further comprising using a normalization function on the second input in order to normalize the second input before said processing using the model.

8. The method of claim 1 further comprising using a loss function on the second output in order to quantify a error present in the time series forecast.

9. The method of claim 1, wherein the model is a transformer model.

10. The method of claim 1, wherein the model is a probabilistic model.

11. An artificial neural network operated in accordance with the method of claim 1.

12. A system comprising:
a processor;
a database storing a time series dataset that is communicatively coupled to the processor; and
a memory that is communicatively coupled to the processor and that has stored thereon computer program code that is executable by the processor and that, when executed by the processor, causes the processor to retrieve the time series dataset from the database and to use the time series dataset to perform the method of claim 1.

13. The system of claim 12 further comprising continuing to iterate using one or more subsequent iterations using the model and the upsampling function until a resolution scale of the time series forecast matches the scale resolution of the time series dataset.

14. The system of claim 12, wherein a resolution scale of the time series forecast matches the scale resolution of the time series dataset.

15. The system of claim 12 further comprising using a same encoder for each of the first iteration and the second iteration.

16. The system of claim 12 further comprising using a different encoder for each of the first iteration and the second iteration.

17. The system of claim 12 further comprising using a normalization function on the initial input in order to normalize the initial input before said processing using the model.

18. The system of claim 12 further comprising using a normalization function on the second input in order to normalize the second input before said processing using the model.

19. The system of claim 12 further comprising using a loss function on the second output in order to quantify a error present in the time series forecast.

20. The system of claim 12, wherein the model is a transformer model.
